(19) United States
(12) Patent Application Publication
(10) Pub. No.: US 2009/0215520 A1
(43) Pub. Date: Aug. 27, 2009

(54) Gaming Machine

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/247,609

(22) Filed: Oct. 8, 2008

Related U.S. Application Data
(60) Provisional application No. 61/031,531, filed on Feb. 26, 2008.

(30) Foreign Application Priority Data
Mar. 12, 2008 (JP) 2008-063201

(51) Int. Cl. A63F 9/24; A63F 13/00

(52) U.S. Cl. 463/20

(57) ABSTRACT

When a predetermined number (for example, three) or more of specific symbols (for example, BELL symbol) are displayed, the reel is variably displayed on each of the symbol display portions on which the specific symbols are not displayed, meanwhile the specific symbols are fixedly displayed on each of the symbol display portions. After that, reels (symbols) are stopped and displayed on each of the symbol display portions on which the specific symbols were not displayed. Then, if a combination of symbols displayed on the symbol display portions correspond to the winning combination, an award corresponding to the winning combination will be provided to the player additionally.

### CROSS-REFERENCE TO RELATED APPLICATIONS

This application is based upon and claims a priority from the U.S. Provisional Patent Application No. 61/031531 filed on Feb. 26, 2008, and the prior Japanese Patent Application No. 2008-063201 filed on Mar. 12, 2008, the entire contents thereof are incorporated herein by reference for all purposes.

### BACKGROUND

1. Field

One or more aspects of the present invention relate to a gaming machine that variably displays symbols on symbol display areas while fixedly displaying a predetermined symbol display area and additionally provides an award based on a combination of stopped and displayed symbols.

2. Description of Related Art

There has existed a gaming machine providing an award depending on the number of specific symbols displayed on a display to enhance an entertainment aspect. Here, to attract players, a gaming machine which has new feature is anticipated.

### SUMMARY

In view of the foregoing, one or more aspects of the present invention relate to a gaming machine, a gaming method thereof, a computer readable medium having computer-executable instructions or the like in which a new gaming environment.

Also, a gaming machine according to one or more aspects of the present invention has a display and a processor. The display has plural symbol display portions displaying symbols. The processor accepts a start indication of a game, variably displays the symbols on the symbol display portions when the start indication is accepted, after that, stop the symbols on the symbol display portions, provides an award corresponding a winning combination if a combination of the displayed symbols is the winning combination, counts number of specific symbols displayed on the symbol display portions, when the number of the specific symbols counted is same or more of than a predetermined number, fixedly displays the specific symbol(s) on symbol display portion(s) and variably displays symbols on symbol display portions on which the specific symbol(s) are not fixedly displayed, and subsequently stops and displays symbols on the symbol display portions on which the specific symbol(s) are not fixedly displayed, and additionally provides an award corresponding to a winning combination if a combination of symbols finally stopped and displayed on the symbol display portions is the winning combination.

Herewith, since an award is additionally provided, the entertainment aspect is enhanced and it can attract players.

Also, a gaming machine according to one or more aspects of the present invention has a display and a processor. The display has plural symbol display portions displaying a video reel having symbols. The processor accepts a start indication of a game, variablys display the video reels on the symbol display portions when the start indication is accepted, after that, stop the symbols on the symbol display portions, provides an award corresponding a winning combination if a combination of the displayed symbols is the winning combination, counts number of specific symbols displayed on the symbol display portions, when the number of the specific symbols counted is same or more of than a predetermined number, fixedly displays the specific symbol(s) on symbol display portion(s) and variably display symbols on symbol display portions on which the specific symbol(s) are not fixedly displayed, and subsequently stops and displays symbols on the symbol display portions on which the specific symbol(s) are not fixedly displayed, and additionally provides an award corresponding to a winning combination if a combination of symbols finally stopped and displayed on the symbol display portions is the winning combination.

Herewith, since an award is additionally provided on a video slot machine, the entertainment aspect is enhanced and it can attract players.

Also, a gaming machine according to one or more aspects of the present invention has a display, motors and a processor. The display has plural symbol display portions displaying a mechanical reel having symbols. The motors spins and stops the mechanical reel. The processor accepts a start indication of a game, variably displays the mechanical reels on the symbol display portions by the motors when the start indication is accepted, after that, stop the symbols on the symbol display portions, provides an award corresponding a winning combination if a combination of the displayed symbols is the winning combination, counts number of specific symbols displayed on the symbol display portions, when the number of the specific symbols counted is same or more of than a predetermined number, fixedly displays the specific symbol(s) on symbol display portion(s) and variably display symbols on symbol display portions on which the specific symbol(s) are not fixedly displayed, and subsequently stops and displays symbols on the symbol display portions on which the specific symbol(s) are not fixedly displayed, and additionally provides an award corresponding to a winning combination if a combination of symbols finally stopped and displayed on the symbol display portions is the winning combination.

Herewith, since an award is additionally provided on a mechanical slot machine, the entertainment aspect is enhanced and it can attract players.

One or more of the above aspects of the invention will be more fully described in the following detailed description when read in connection with the accompanying drawings. It is to be expressly understood, however, that the drawings are for purpose of illustration only and not intended as a definition of the limits of the invention.

### BRIEF DESCRIPTION OF THE DRAWINGS

FIG. 1 is a view showing an example of a display contents according to one or more aspects of the invention.

FIG. 2 is a perspective view showing an outer appearance of a slot machine according to one or more aspects of the invention.

FIG. 3 is a view showing symbol display portions of the slot machine according to one or more aspects of the invention.

FIG. 4 is a block diagram showing an internal configuration of the slot machine according to one or more aspects of the invention.

FIG. 5 is a block diagram showing an internal configuration of a sub-control board of the slot machine according to one or more aspects of the invention.

FIG. 6 is a view showing symbols displayed on each reel of the slot machine according to one or more aspects of the invention.

FIG. 7 is a view showing symbol rows displayed on each reel of the slot machine according to one or more aspects of the invention.

FIG. 8 is a view showing a condition where reels are variably displayed on variably displays of the slot machine according to one or more aspects of the invention.

FIG. 9 is a view showing a condition where symbols are stopped and displayed on variably displays of the slot machine according to one or more aspects of the invention.

FIG. 10 is a view showing contents of payout table of the slot machine according to one or more aspects of the invention.

FIG. 11 is a flowchart of a main control process in the slot machine according to one or more aspects of the invention.

FIG. 12 is a flowchart of a main game process in the slot machine according to one or more aspects of the invention.

FIG. 13 is a flowchart of a main game process in the slot machine according to one or more aspects of the invention.

FIG. 14 is a view showing a table in which each of code numbers corresponds to symbol in the slot machine according to one or more aspects of the invention.

FIG. 15 is a view showing a table in which random number values correspond to code number in the slot machine according to one or more aspects of the invention.

FIG. 16 is a view showing a table in which random number values correspond to symbol in the slot machine according to one or more aspects of the invention.

FIG. 17 is a view showing an example of a display contents according to one or more aspects of the invention.

FIG. 18 is a view showing an example of a display contents according to one or more aspects of the invention.

FIG. 19 is a view showing an example of a display contents according to one or more aspects of the invention.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine, a server, and a game system according to one or more aspects of the invention will be described in detail with reference to the drawings based on an embodiment embodying one or more aspects of the invention. However, it is appreciated that one or more aspects of the present invention may be embodied in distributable (via CD and the like) or downloadable software games, console games, and the like. In this regard, the slot machine may be a virtual slot machine that is displayed on a multi-purpose computer and/or dedicated kiosk. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU”, “processor”, and “controller” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

A gaming machine related to the invention will be described in detail with reference to drawings based on a slot machine embodiment. A slot machine 1 according to the embodiment, for example, has a image display device like a liquid crystal display. The slot machine 1 displays images of various symbols on the image display device to execute a game. Namely, the slot machine 1 according to the embodiment can be implemented as a video slot machine. Also, the variably display portion 3B can be hybrid type slot machine which is made up of mechanical reels and transparent liquid crystal display device arranged in front of the mechanical reels. Also, the slot machine 1 according to the embodiment can be implemented as a mechanical slot machine having mechanical reels. Here, in following explanation, slot machines using video reels are mainly described, however, naturally, the present invention is can be applied to slot machines using mechanical reels within applicable limits.

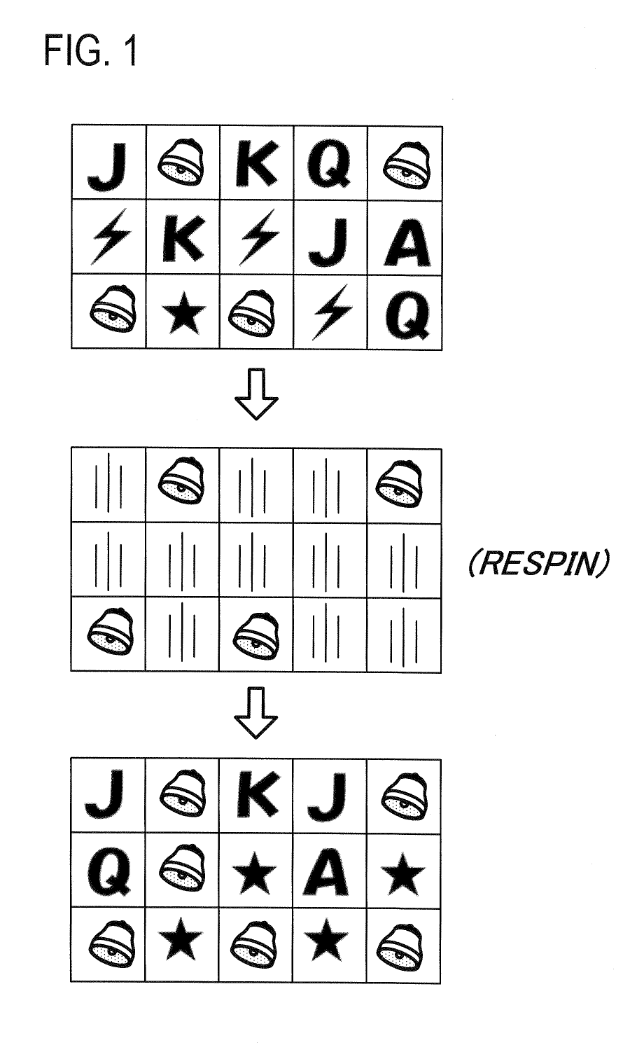

A slot machine 1 according to the embodiment, when specific symbols (for example, a BELL symbol) are displayed with a predetermined number (for example, three) (see upper row of FIG. 1), the reel(symbol) is variably displayed on each of the symbol display portions on which the specific symbols are not displayed, meanwhile the specific symbols (the BELL symbol) are fixedly displayed on each of the symbol display portions (see middle row of FIG. 1). After that, the symbols are stopped and displayed on each of the symbol display portions on which the specific symbols are not displayed (see lower row of FIG. 1). Then, if the symbols displayed on the symbol display portions correspond to the winning combination, an award corresponding to the winning combination will be provided to the player incrementally.

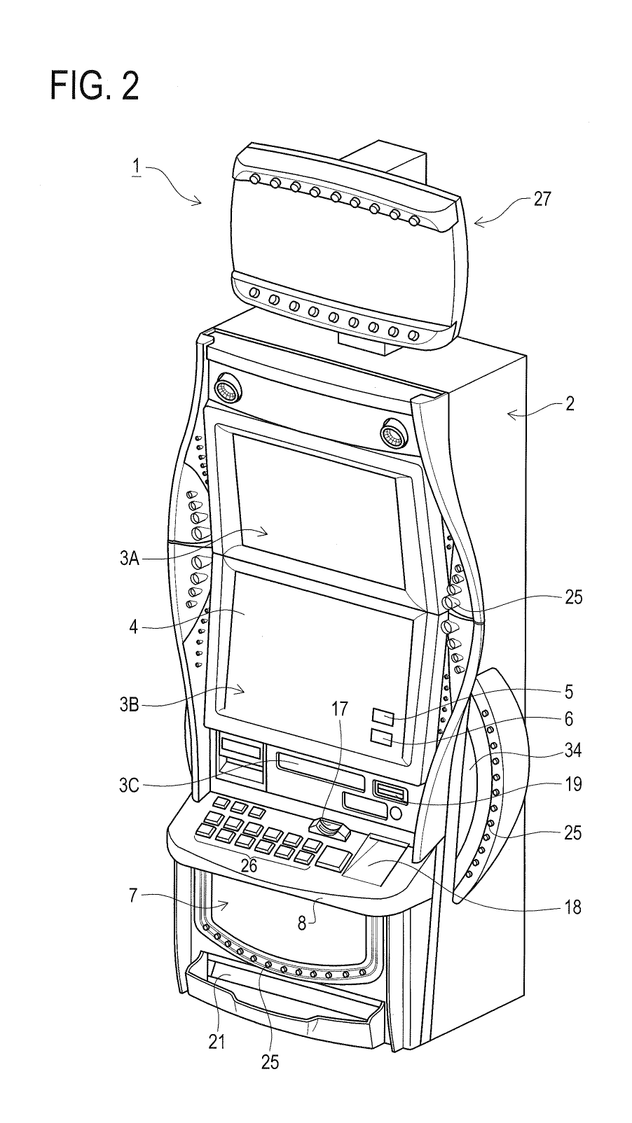

At first, a schematic configuration of a slot machine 1 according to the first embodiment will be described with reference to Figure. FIG. 2 is a perspective view showing an outer appearance of the slot machine 1 according to the first embodiment. The slot machine 1 according to the first embodiment is an upright-type slot machine positioned in a gaming arcade such as a casino or the like. Here, the outer shape of the slot machine 1 as shown in the description of the first embodiment is given as merely one example, and one or more aspects of the invention is not limited to this outer shape.

The slot machine 1 has a cabinet 2. The cabinet 2 is a housing portion that houses electrical or mechanical components which are used in execution of a predetermined game aspect.

An upper display portion 3A, a main display portion 3B, and an under display portion 3C are arranged in front of the slot machine 1 so as to display different type of game information. The upper display portion 3A is arranged upper side of the cabinet 2, the main display portion 3B is arranged middle side of the cabinet 2, and the under display portion 3C is arranged lower side of the cabinet 2.

The upper display portion 3A is constructed from a liquid crystal panel. Effects images, payout tables of games, game rules, or the like are displayed on the upper display portion 3A.

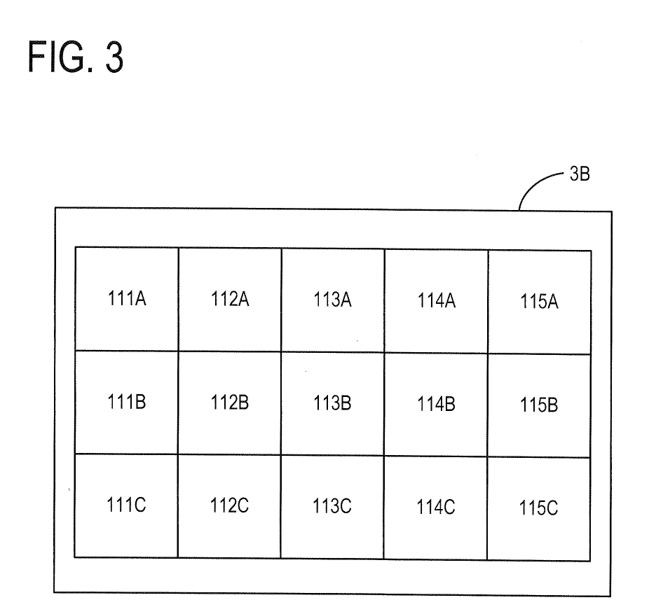

The main display portion 3B is constructed from a liquid crystal panel. For example, as shown in FIG. 3, fifteen of symbol display portions 111A to 115A, 111B to 115B, and 111C to 115C are displayed with 3×5 matrix shape on the main display portion 3B.

Also, on each of the reel display portions, symbol rows are variably displayed. Also, plural symbols are displayed on the reels. When reels are stopped, one symbol will be stopped on the symbol display portion. In the embodiment, each of the symbol display portions corresponds to one reel. That is, in the embodiment, fifteen reels are used. Here, the number of the symbol display portions can be set arbitrarily.

A touch panel 4 is provided at a front face of the main display portion 3B. The player can operate the touch panel 4 to input various types of commands. Also, a payout number display portion 5 and a credit number display portion 6 are arranged on the main display portion 3B. The displayed position of the payout number display portion 5 and the credit number display portion 6 are variable. For example, these are displayed on lower right side portion of the main display portion 3B. Also, a bet number display portion may be arranged so as to display bet number. The payout number which will be provided to the player (that is, payout number to be provided when predetermined symbols are displayed with the predetermined number in a game and free games) are displayed on the payout number display portion 5. The credit number which the player currently owns is displayed on the credit number display portion 6.

The under display portion 3C is constructed from a liquid crystal panel. Number of points stored in a card and/or number of game points are displayed on the under display portion 3C. Also, when the card is not inserted and/or error of reading the card occurs, message which indicates that is displayed. Also, a card reader 19 is arranged around the under display portion 3C. The card reader 19 can read information from the card in which the player owns.

The upper display portion 3A, the main display portion 3B, and the under display portion 3C are constructed from the liquid display for example, however, one or more aspects of the invention is not so limited. That is, each of the display portion can be CRT displays, plasma displays, LED displays, or other known display devices.

A lower back panel 7 is arranged lower side of the under display portion 3C and is constructed from plastic panel. Character pictures related to the gaming machine, name of the gaming machine, and the like are displayed and the lower back panel is lit by the backlight. The lower back panel 7 can be CRT displays, plasma displays, LED displays, or other known display devices.

Also, the main display portion 3B can be hybrid type slot machine which is made up of mechanical reels and transparent liquid crystal display device arranged in front of the mechanical reels. In this case, symbols displayed on the mechanical reels are visible perceived via the transparent liquid crystal display device. Also, it is preferable that display windows whose number is the same as the number of the mechanical reels is arranged on the transparent liquid crystal display device and it is constructed so that symbols displayed on the mechanical reels are visible perceived via the window displays. Here, in following explanation, slot machines using video reels are mainly described, however, naturally, the present invention is can be applied to slot machines using mechanical reels within applicable limits. Also, if the mechanical reels are used, the mechanical reels are spin and stopped by motors which are not shown.

An operation table 8 formed by projecting to proximal side is provided at the bottom of the main display portion 3B. Various operation buttons 26, such as an exchange button, a payout button, a help button, a bet button, and start button or the like, are arranged on the operation table 8. An arrangement of these buttons is variable. Also, a part of the buttons can be omitted, and new button can be added or replaced, as needed. Also, a coin insertion slot 17 and a bill verifier 18 are arranged on the operation table 8.

Also, a coin payout opening and a coin receiving portion 21 is formed on lower portion of the cabinet 2. The coin payout opening is a portion where coins are paid out based on inputs of the exchange button or the payout button. And, the coin receiving portion 21 is a portion where the coins which are paid out from the coin payout opening are received. A coin detection portion made up of sensor or the like is arranged inside the coin payout opening. The coin detection portion detects the number of coins which are paid out from the payout opening.

Light emitting portions 25, which lights up in a predetermined lighting pattern when winning combination is realized and during the free game, are arranged around the cabinet 2 of the slot machine 1. Loudspeakers 34 which outputs audio are arranged at side of the cabinet 2. Here, arranged positions of the light emitting portion 25 and the loudspeaker 34 are variable.

The slot machine 1 has a topper effect device 27 provided at an upper side of the cabinet 2. This topper effect device 27 has a rectangular board shape and is arranged so as to be substantially parallel with the upper display portion 3A. Here, the shape of the topper effect device 27 is variable. Different types of information are displayed on the topper effect device 27.

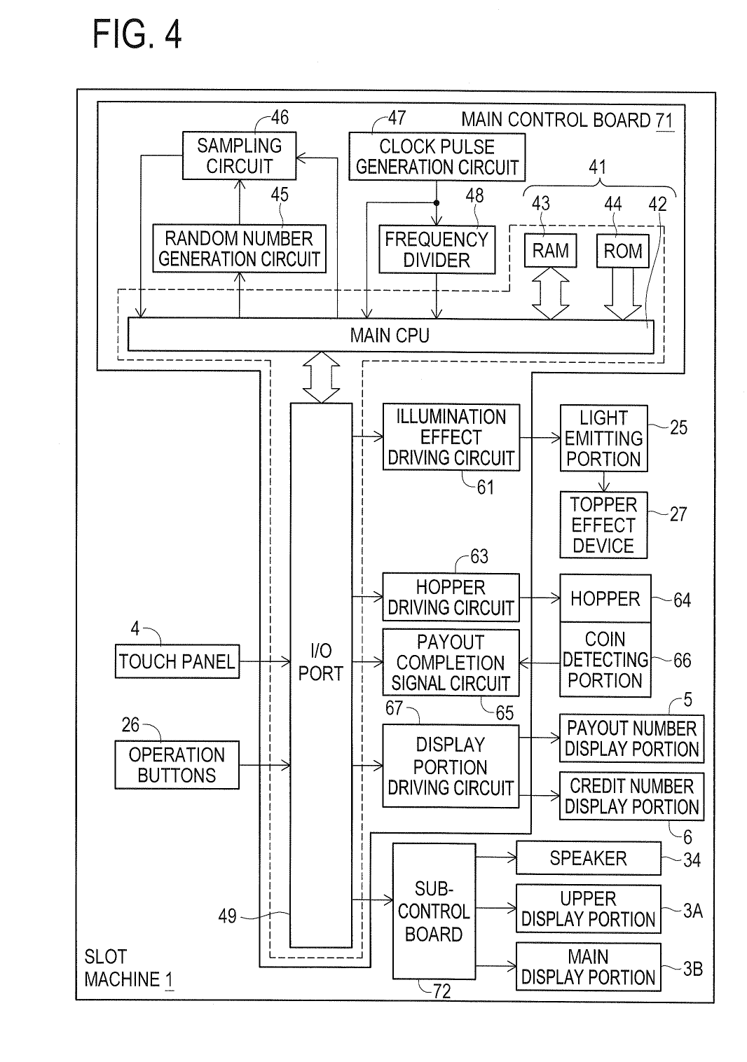

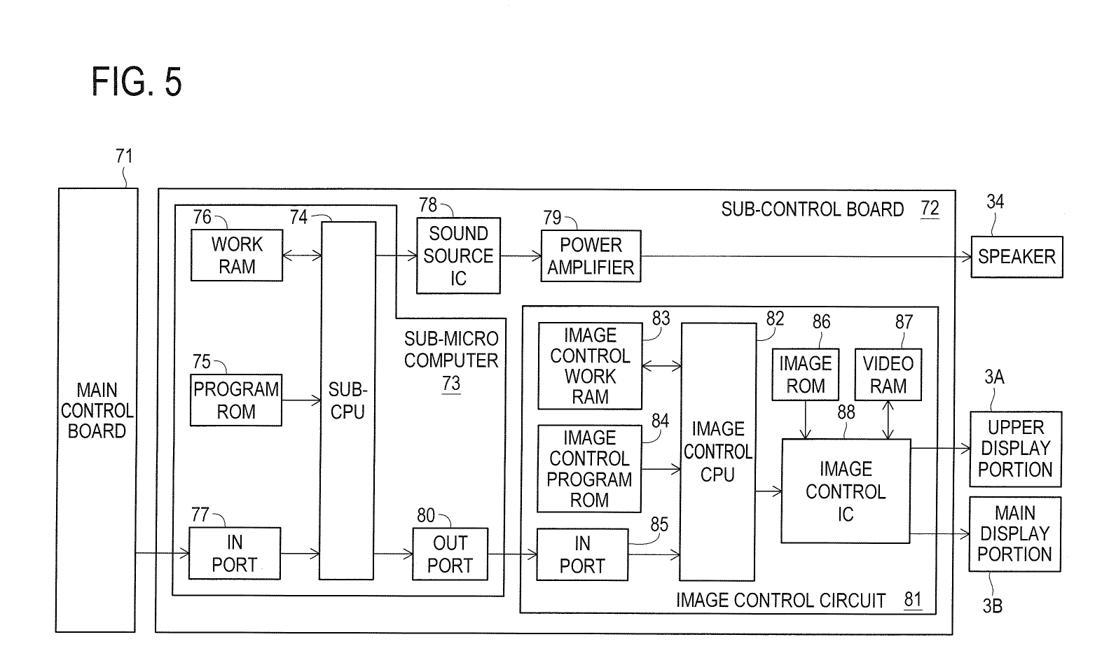

Next, the internal configuration of the above-mentioned slot machine 1 will be described with reference to FIG. 4 and FIG. 5. FIG. 4 is a block diagram showing an internal configuration of the entire slot machine 1. As shown in FIG. 4, the slot machine 1 has a plurality of constituent elements arranged around a main control board 71 including a controller 41 that executes control programs that will be described later. The main control board 71 has a controller 41, a random number generation circuit 45, a sampling circuit 46, a clock pulse generation circuit 47, a divider 48, an illumination effect driving circuit 61, a hopper driving circuit 63, a payout completion signal circuit 65 and a display portion driving circuit 67.

The controller 41 has a main CPU 42, a RAM 43 and a ROM 44. The main CPU 42 operates in accordance with the programs stored in the ROM 44 and performs signal input and output with respect to the other constituent elements through an I/O port 49. Specifically, the main CPU 42 controls the operation of the entire slot machine 1. The RAM 43 stores data and programs to be used when the main CPU 42 is operating. For instance, the RAM 43 temporarily retains the random number values which have been sampled by the sampling circuit 46 after the game has started. The RAM 43 stores code numbers that will be described later.

The ROM 44 stores various types of programs that will be executed by the main CPU 42, as well as permanent data. The programs stored in the ROM 44 include game programs and game system programs (hereinafter referred to as game programs or the like). Further, the game programs include lottery programs. Also, if the slot machine according to present embodiment is implemented as a video slot machine, images of symbols which comprising the video reels are stored in the ROM 44.

The lottery programs are used to determine the code numbers corresponding to symbols to be displayed on each symbol display portion of the main display portion 3B. Correspondence relationships between the code numbers and the symbols will be described later.

The random number generation circuit 45 operates in accordance with the commands from the main CPU 42 and generates random numbers within a predetermined range. The sampling circuit 46 selects, by lottery, an arbitrary random number from the random numbers generated by the random number generation circuit 45 in response to a command from the main CPU 42. At the same time, the sampling circuit 46 inputs the random number thus selected to the main CPU 42. The clock pulse generation circuit 47 generates a reference clock for causing the main CPU 42 to operate. The divider 48 inputs a signal obtained by dividing the reference clock by a constant frequency to the main CPU 42.

The main control board 71 is connected to the touch panel 4. As described above, the touch panel 4 is arranged at a front face of the main display portion 3B and is adapted to identify a coordinate position of the portion that was touched by the player. Specifically, the touch panel 4 can discriminate the portion that the player has touched, and in what direction the touched portion was moved based on the coordinate position information that was thus identified. A signal in accordance with the above discrimination is then inputted to the main CPU 42 through the I/O port 49.

The main control board 71 is connected to the operation button 26 (the start button and the like, as mentioned above) and a signal in accordance with a depression operation of these buttons is inputted to the main CPU 42 through the I/O port 49.

The illumination effect driving circuit 61 outputs an effect signal for causing the light emitting portions 25 and the topper effect device 27 as mentioned above to perform illumination effects. The topper effect device 27 is connected in series with the illumination effect driving circuit 61 through the light emitting portions 25.

The hopper driving circuit 63 drives the hopper 64 under the control of the main CPU 42. As a result, the hopper 64 carries out an operation to payout coins to the coin payout opening. The payout completion signal circuit 65 receives coin amount value data from the coin detecting portion 66 to which it is connected. Then, when the received coin amount value has reached the set coin amount value, the payout completion signal circuit 65 inputs a signal that notifies completion of coin payout to the main CPU 42. The coin detecting portion 66 detects the number of coins that were paid out by the hopper 64 and then inputs coin amount value data showing the amount of coins that was detected to the payout completion signal circuit 65. The display portion driving circuit 67 controls the display operation of the respective display portions including the payout number display portion 5, the credit number display portion 6, and the like.

The main control board 71 is connected to the sub-control board 72. As shown in FIG. 5, the sub-control board 72 carries out display control of each of the display portion and output control of the audio outputted by the loudspeaker 34, based on the commands received from the main control board 71. This sub-control board 72 is constituted on a separate circuit board from the circuit board that constitutes the main control board 71. The sub-control board 72 has a micro computer (hereinafter referred to as “sub-micro computer”) 73 which is provided as a main constituting element. Then, the sub-control board 72 has a sound source IC 78, a power amplifier 79, and an image control circuit 81. The sound source IC 78 controls the audio output from the loudspeaker 34. The power amplifier 79 functions as an amplifier. The image control circuit 81 operates as a display control section for the upper display portion 3A and the main display portion 3B.

The sub-micro computer 73 has a sub-CPU 74, a program ROM 75, a work RAM 76 and I/O ports 77 and 80. The sub-CPU 74 carries out a control operation in accordance with a control command transmitted from the main control board 71. Although the sub-control board 72 does not have a clock pulse generation circuit, a divider, a random number generation circuit and a sampling circuit, it is constituted so as to execute sampling of random numbers based on an operation program of the sub-CPU 74. The program ROM 75 stores a control program to be executed by the sub-CPU 74. The work RAM 76 is constituted as a temporary memory to be used by the sub CPU 74 in executing the control program.

The image control circuit 81 has an image control CPU 82, an image control work RAM 83, an image control program ROM 84, an in port 85, an image ROM 86, a video RAM 87 and an image control IC 88. The image control CPU 82 determines the image to be displayed on the upper display portion 3A and the main display portion 3B based on the parameters set in the sub-micro computer 73 and the image control programs stored in the image control program ROM 84. For example, the upper display portion 3A displays a payout table and a help screen. The main display portion 3B carries out scrolled display and stopped display on the respective symbol display portions 111A to 111C, 112A to 112C, 113A to 113C, 114A to 114C, and 115A to 115C.

The image control program ROM 84 stores an image control program and various types of selection tables relating to display on the upper display portion 3A and the main display portion 3B. The image control work RAM 83 functions as a temporary memory to be used in execution of the image control program in the image control CPU 82. The image control IC 88 forms an image in accordance with the contents determined by the image control CPU 82 and then outputs the image thus formed to the upper display portion 3A and the main display portion 3B.

The image ROM 86 stores dot data for forming an image. The video RAM 87 functions as a temporary memory to be used by the image control IC 88 in forming an image.

Here, the internal construction of the slot machine 1 as mentioned above is merely one example and one or more aspects of the embodiment is not so limited. For example, memory card and/or PLD (Programmable Logic Device) may be detachably from the slot machine 1 and necessary information may be read from the memory card and/or the PLD.

The slot machine 1 of the embodiment employs coins, bills or electronic value information (credit) corresponding to these, as gaming values. The gaming values applicable to the present invention are not limited to those described above, and can include, for instance, medals, tokens, electronic money and tickets. Here, in the present embodiment, the credit is mainly described as being awarded, however, naturally, the present invention is not limited to the embodiment.

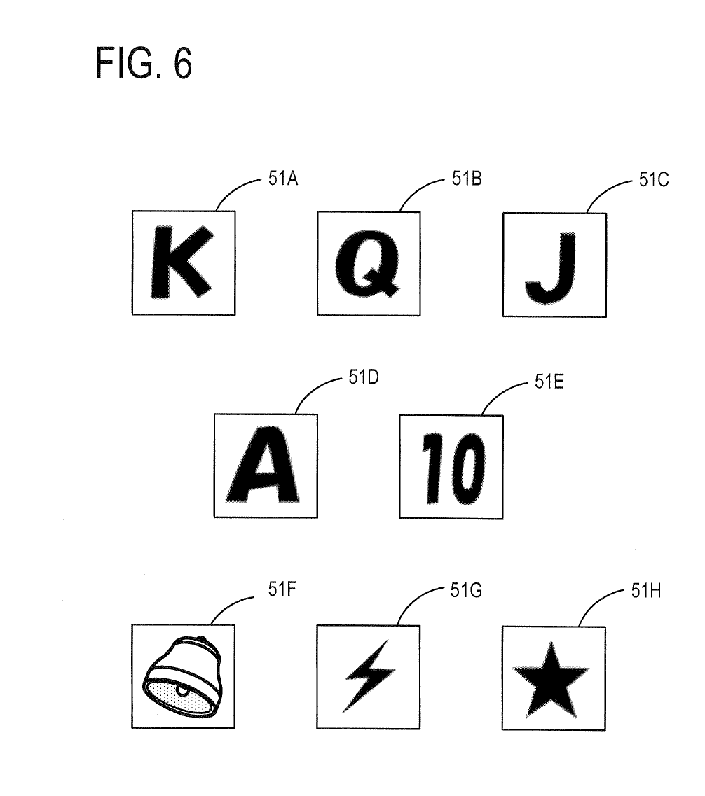

Next, the symbols which are variably displayed on the symbols display portion will be described with reference to FIG. 6. FIG. 6 is a view schematically showing the symbols displayed on the reels which are variably displayed on the symbol display portions.

The symbols used in present embodiment includes KING symbol 51A, QUEEN symbol 51B, JACK symbol 51C, ACE symbol 51D, TEN symbol 51E, BELL symbol 51F, THUNDER symbol 51G, STAR symbol 51H.

The number of the symbols which are displayed on one reel is variable and the type of the displayed symbols is variable.

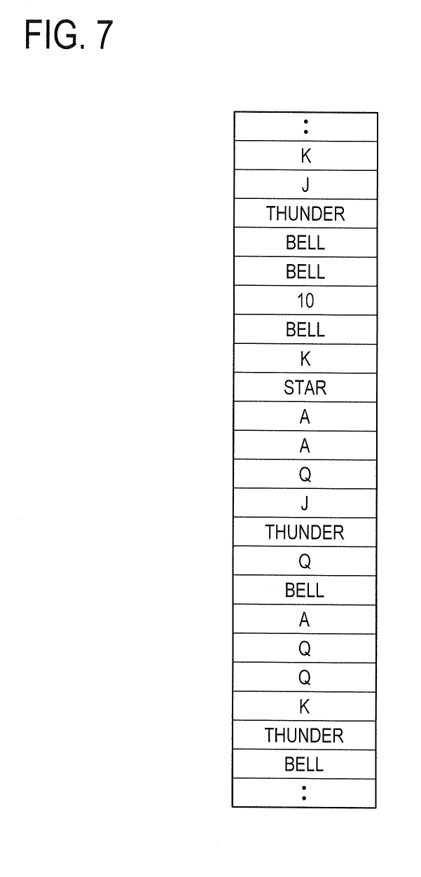

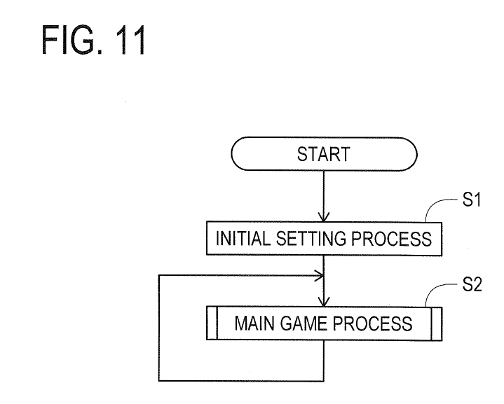

FIG. 7 is a view schematically showing the symbols displayed on the reels which are variably displayed on the symbol display portions. Symbols shown in FIG. 6 are displayed on the reel in predetermined order, as shown in FIG. 7. Here, the order of symbol shown in FIG. 11 is merely one example, and the order of symbol is variable. Also, the reels can be different on each symbol display portions. Also, plural reels are provided for each symbol display portions, and the reel can be selected based on the payout ratio which is set.

Next, games executed in the slot machine 1 of the embodiment will be described. The games executed in the embodiment are constructed from two of games. The two of games is the base game and the free game.

First, the base game will be described. In the base game, a winning combination is determined based on the number of same symbols displayed on the symbols display portions 111A to 115A, 111B to 115B, and 111C to 115C on the main display portion 3B, and an award corresponding to the winning combination is provided.

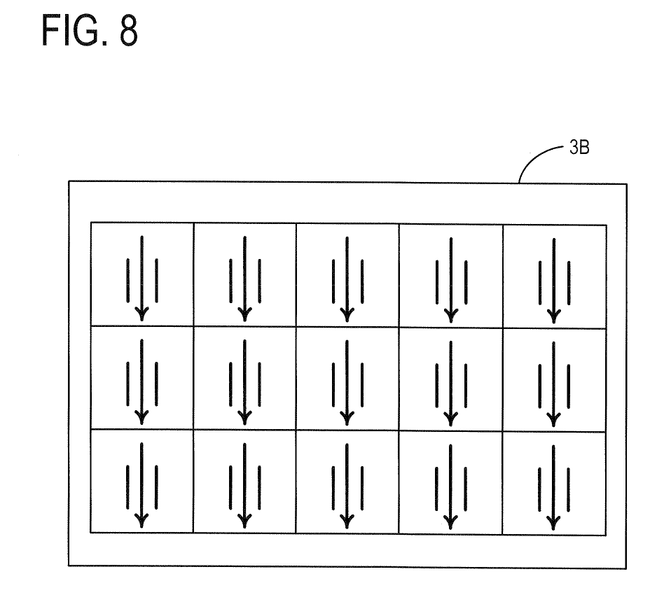

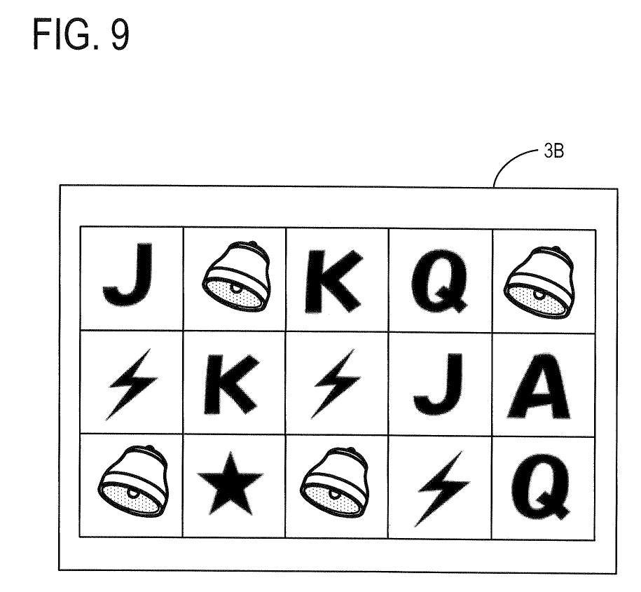

When the bet count is determined based on the operation of the bet button, and then the start button is input, the reels start to spin on the each of the symbol display portions. Accordingly, the symbol rows displayed on the reel are variably displayed, as shown in FIG. 8. After a predetermined time, the reels are stopped and displayed on the symbol display portions. Accordingly, a symbol of the reel is displayed in the symbol display portion on the main display portion 3B respectively, as shown in FIG. 9. Here, scroll direction can be from the bottom to top not limited to from top to bottom. Also, the scroll direction can be different on each reel display portion. Also, the scroll direction can be different on each game.

In present embodiment, stop order of the symbols displayed on the symbol display portions can be set arbitrarily. Namely, all of the reels displayed on the symbol display portions (111A to 115A, 111B to 115B and 111C to 115C) can stop simultaneously. After the reels have stopped, a winning combination is determined based on the number of the same symbols on the main display portion 3B and an award corresponding to the determined winning combination will be provided. If the winning combination is realized, amount of outcome, which the payout number corresponding to the winning combination is multiplied by the bet number, is provided to the player.

Next, the free game will be described. The free game is executed if a predetermined number(for example, three) or more of scatter symbols (in the present embodiment, STAR symbol 51H) are displayed on the symbol display portions 111A to 115A, 111B to 115B and 111C to 115C. Here, with respect to the procedure of the free game, the free game is the same as the base game, except that in the free game, gaming values (credits) corresponding to the bet amount are not consumed at the start of the game, and the game is continuously carried out automatically without requiring the player to operate the operation button.

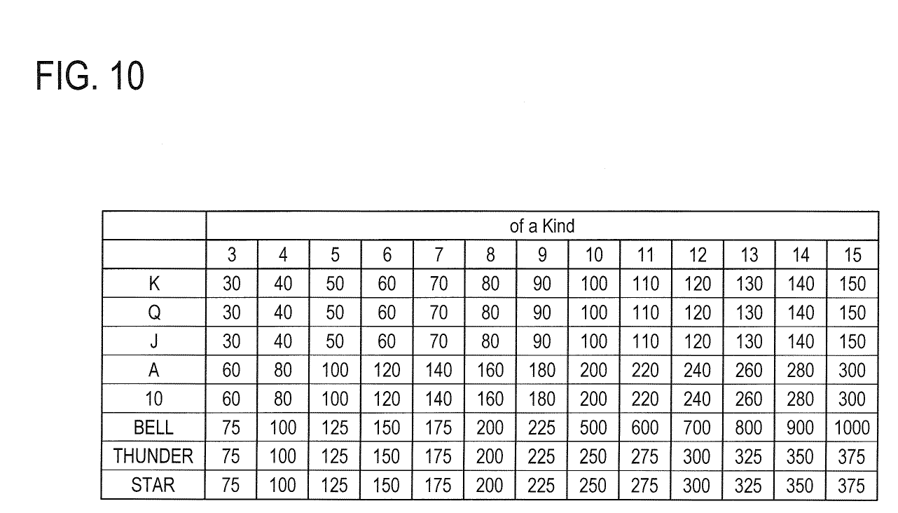

The winning combination and payout number thereof used in the base game and the free game in the slot machine 1 of the embodiment will be described with reference to FIG. 10. FIG. 10 shows payout table which indicates the winning combination and payout number thereof used in the game.

FIG. 10 indicates the payout number in the case where the bet count is “1”. If the bet count is “1”, the payout number shown in FIG. 10 will be provided. If the bet count is more than “2”, the payout number shown in FIG. 10 will be multiplied by the bet count, and multiplied number will be provided.

For example, if five of King symbol 51A are displayed on the symbol display portions 111A to 115A, 111B to 115B and 111C to 115C, amount of outcome which 50 credit is multiplied by the bet number will be provided to the player.

For example, if four of Ace symbol 51D are displayed on symbol display portions from the symbol display portions 111A to 115A, 111B to 115B and 111C to 115C, amount of outcome which 80 credit is multiplied by the bet number will be provided to the player.

In a similar way, the payout numbers are defined on each of the winning combinations shown in FIG. 10. Here, the combination on the symbol display portions 111A to 115A, 111B to 115B and 111C to 115C not associated with any of the winning combinations shown in FIG. 10 is realized, the game is lost. If the game is lost, none of the payout number will be paid.

Here, the payout table shown in FIG. 10 is merely one example, and the types of the winning combinations and the payout number is variable. Also, in one or more aspects of the invention, plural payout tables are provided and the payout table can be selected based on the payout ratio which is set. Also, payout table used in the free game can be different from the payout table used in the base game.

Next, a main control program executed in the slot machine 1 of the embodiment will be described in detail with reference to drawings. FIG. 11 is a flowchart of the main control program.

First, when the power switch is turned on (upon power on), the main control board 71 and the sub-control board 72 are activated, and the controller 41 executes an initial setting process at S1. In the initial setting process, the main CPU 42 executes the BIOS stored in the ROM 44 and expands the compressed data incorporated in the BIOS in the RAM 43. By executing the BIOS that was expanded in the RAM 43, the main CPU 42 carries out a diagnosis and initialization of the different types of peripheral devices. Further, the main CPU 42 writes the game programs and the like from the ROM 44 into the RAM 43 to acquire payout rate setting data and country identification information. While executing the initial setting process, the main CPU 42 also carries out an authentication process with respect to each program.

Then, at step S2, the main CPU 42 sequentially reads the game programs and the like from the RAM 43 and executes these programs to carry out a main game process. The slot machine 1 according to the embodiment carries out the game by executing this main game process. The main game process is repeatedly executed while power is supplied to the slot machine 1.

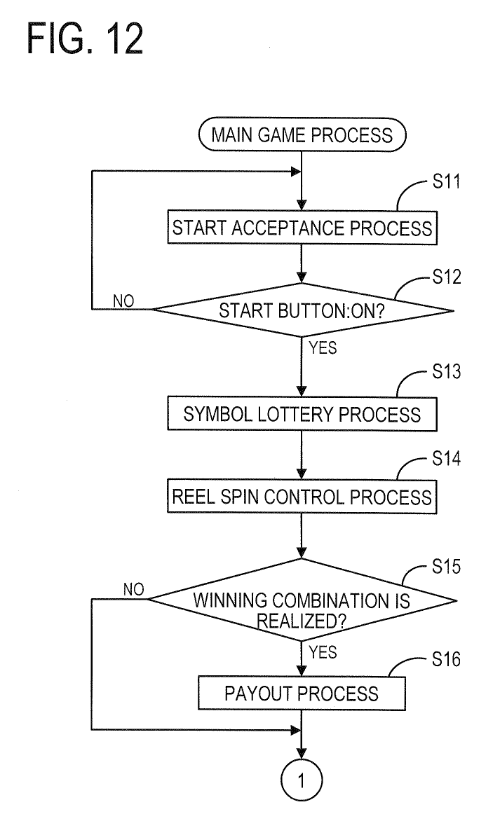

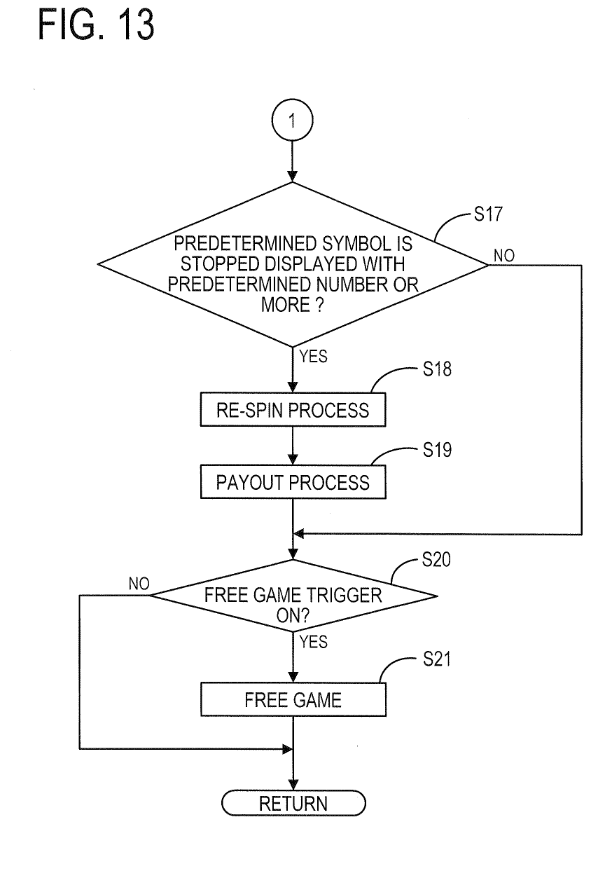

Next, a sub-process of the main game process at the above-described step S2 will be described based on FIG. 12 and FIG. 13. FIG. 12 is a flowchart of the main game process program to be executed in the slot machine 1 according to the embodiment. The programs of the flowcharts as will be described later are stored in the ROM 44 and RAM 43 provided in the slot machine 1 and are executed in the main CPU 42.

The main CPU 42 first executes a start acceptance process at S11. In the start acceptance process, the player inserts coins and places a bet using the BET button from amongst the operation buttons 26.

At S12, the main CPU 42 determines whether or not the start button from amongst the operation buttons 26 has been depressed. This determination is carried out based on the signal inputted to the main CPU 42 in response to depression of the start button. Here, if the start button has not been depressed (S12: NO), the flow returns to the start acceptance process (S11). As a result, the player can carry out an operation to correct, etc. the bet amount at S11. Alternatively, if the start button has been depressed (S12: YES), the main CPU 42 subtracts the bet amount set based on the above-described bet operation from the credit amount that the player currently possesses and at the same time stores the result as bet information in the RAM 43. After that, the procedure will be shifted to S13.

At S13, the symbol lottery process is executed. Concretely, the main CPU 42 samples random number value from a number value range within a predetermined random number value range by executing the lottery program stored in the RAM 43, and determines symbols to be stopped on each symbol display portions based on the sampled random number values and the table.

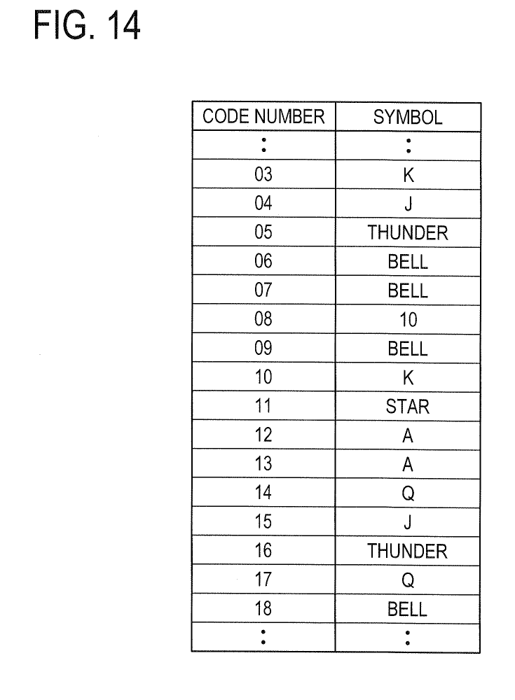

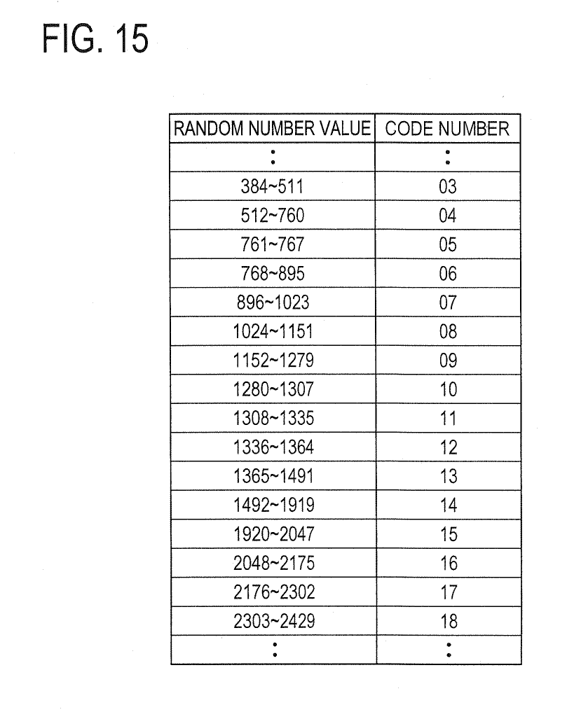

Here, a process at S13 will be described. FIG. 14 shows one example of a table in which symbols displaying on the reel shown in FIG. 7 correspond to code numbers. FIG. 15 shows one example of a table in which the random number values corresponds to the code numbers. The code numbers are determined with the use of the table shown in FIG. 15 based on the sampled random number values among predetermined random number range (for example, from 0 to 65535). The symbols to be stopped are determined with the use of the determined code numbers and the table shown in FIG. 14.

Here, as shown in FIG. 15, since the number of random number values corresponding to each code number is different, each of probabilities of appearance of each symbol shown in FIG. 14 is controlled. For example, in FIG. 15, code number “4” corresponds to random number values “512” to “760”, code number “5” corresponds to “761” to “767”. Therefore, since the code number “4” may more appear than the code number “5”, JACK symbol 51C corresponding to the code number “4” may more appear than the THUNDER symbol 51G corresponding to the code number “5” on the reel shown in FIG. 7.

For example, with respect to the symbol display portion 113A, in a case where reel shown in FIG. 7 is used and “1136” is sampled, it is determined that code number is “8” based on the table shown in FIG. 15. And then, it is determined that the TEN symbol 51E corresponding to the code number “8” will be displayed on the symbol display portion 113A with the use of the table shown in FIG. 14.

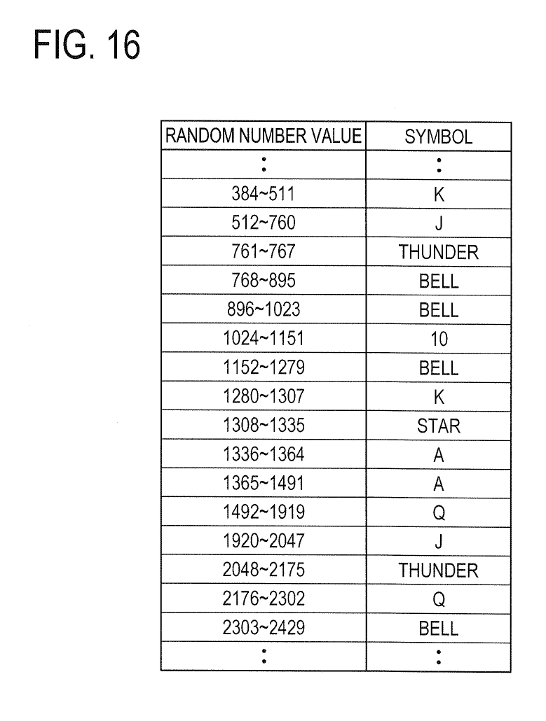

Also, as shown in FIG. 16, the random number values to be sampled may correspond to symbols.

Returning to FIG. 12, at S14, the main CPU 42 carries out a reel spin control process. Specifically, the main CPU 42 variably displays each of the reels on the symbol display portions 111A to 115A, 111B to 115B and 111C to 115C. After that, the main CPU 42 determines effects pattern (image display pattern of the main display portion 3B, sound output pattern of the loudspeaker 34, or the like) in a unit game and starts effects based on the determined effects pattern. Here, the unit game means a sequence of process where each of the reels starts to variably display and then the entire reels are stopped and displayed.

Then, after the lapse of a predetermined period of time, reels are stopped to spin on the symbol display portions 111A to 115A, 111B to 115B and 111C to 115C in predetermined order. Therefore, symbols are stopped displayed on symbol display portions 111A to 111C, 112A to 112C, 113A to 113C, 114A to 114C, and 115A to 115C.

After that, at S15, the main CPU 42 determines whether or not the symbols arranged on the main display portion 3B correspond the winning combination. This determination is performed based on the code numbers of each symbol display portion 111A to 115A, 111B to 115B and 111C to 115C stored in the RAM 43.

If it is determined that the winning combination is realized (S15:YES), the procedure will be shifted to S16. On the other hand, if it is determined that none of the winning combinations is not realized (S15:NO), the procedure will be shifted to S17.

At S16, the main CPU 42 provides the payout number corresponding to the winning combination which is determined at S15 to the player. After that, the procedure will be shifted to S17.

At S17, it is determined whether or not a predetermined number or more of specific symbols are stopped. In this embodiment, when three or more of the BELL symbols 51F are stopped, a “YES” determination is done at S17.

If the “YES” determination is done at S17 (S17:YES), the procedure will be shifted to S18. On the other hand, if it is determined that three or more of the BELL symbols 51F are not stopped (S17:NO), the procedure will be shifted to S20.

At S18, a re-spin process is executed at the symbol display portions where symbols other than the BELL symbol 51F were stopped. Namely, an additional game is executed during the base game execution. In the re-spin process, a symbol display portion which variably displays the reel is determined. Then, the symbol lottery process (S13) and the reel spinning control process (S14) mentioned above are executed for the symbol display portion determined at S18. Namely, the reel is variably displayed on the symbol display portion determined at S18, then symbols on the reel are stopped. After that, the procedure will be shifted to S19.

At S19, a payout process is executed. The payout process at S19 is same as the payout process at S16, an explanation is omitted.

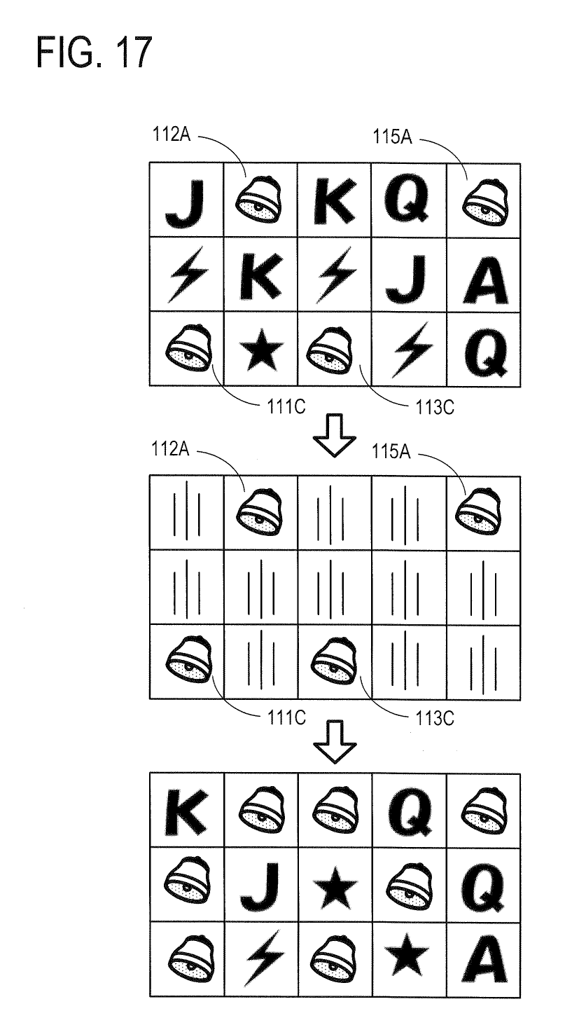

FIG. 17 is an example of display contents of the symbol display portion. An upper row of FIG. 17 shows the symbols stopped on the each of the symbol display portions according to the reel spinning control process at S14. As shown in the upper row of FIG. 17, BELL symbol 51F (scatter symbols) are displayed on the symbol display portions 112A, 115A, 111C, and 113C. Namely, four scatter symbols are displayed.

According to the upper row of FIG. 17, there will be paid out amount corresponding to the product of “100” credit, associated with “4 of a kind” of the BELL symbol 51F, by the bet number (see FIG. 10). Also, According to the upper row of FIG. 17, amount of outcome (in which “75” credit corresponding to “3 of a kind” of the THUNDER symbol 51G is multiplied by the bet number) will be provided to the player (see FIG. 10). Namely, amount of outcome (in which total of “175” credit is multiplied by the bet number) will be provided to the player.

As three or more of the BELL symbols 51F are displayed, the “YES” determination is done at S17. As shown in the middle row of FIG. 17, the reel is variably displayed on each of the symbol display portions 111A, 113A, 114A, 111B to 115B, 112C, 114C and 115C, meanwhile the reel is fixedly displayed on each of the symbol display portions 112A, 115A, 111C, and 113C.

After that, as shown in the lower row of FIG. 17, symbols are stopped and displayed on each of the symbol display portions. Winning combination is determined based on the number of the same symbols displayed on the symbol display portions 111A to 115A, 111B to 115B and 111C to 115C in the main display portion 3B. Then, an award corresponding to the determined winning combination will be provided to the player additionally. According to the lower row of FIG. 17, amount of outcome which “175” credit corresponding to “7 of a kind” of the BELL symbol 51F is multiplied by the bet number will be provided to the player incrementally (see FIG. 10).

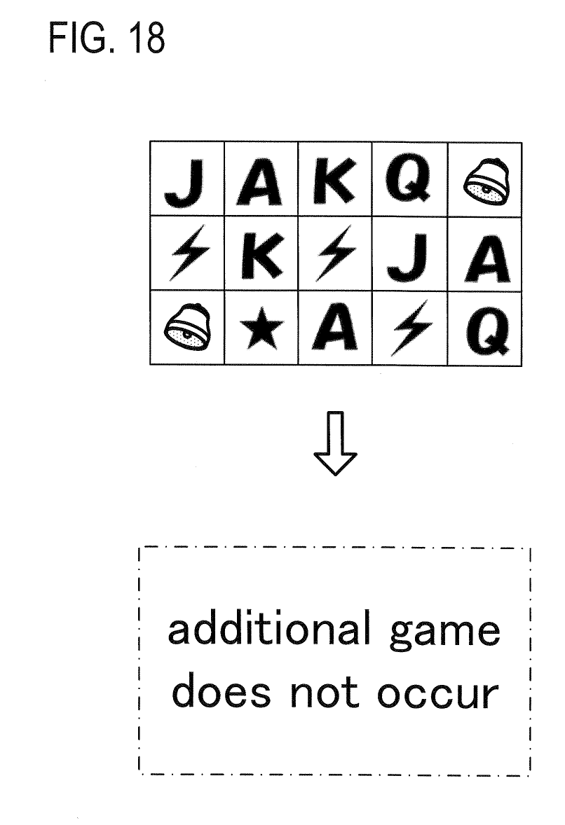

FIG. 18 is an example of display contents of the symbol display portion. An upper row of FIG. 18 shows the symbols stopped on the each of the symbol display portions according to the reel spinning control process at S14. As shown in the upper row of FIG. 18, two scatter symbols are displayed. Therefore, a “NO” determination is done at S17. And the additional game is not executed.

Returning to FIG. 12, at S20, the main CPU 42 determines whether or not a free game trigger is realized. This determination is based on whether or not a predetermined number or more of the predetermined symbols are displayed, as described above. If the free game trigger has been realized (S19: YES), the procedure will be shifted to S20. At S20, the free is executed.

On the other hand, if the free game trigger has not been realized (S19: NO), the main game process is terminated.

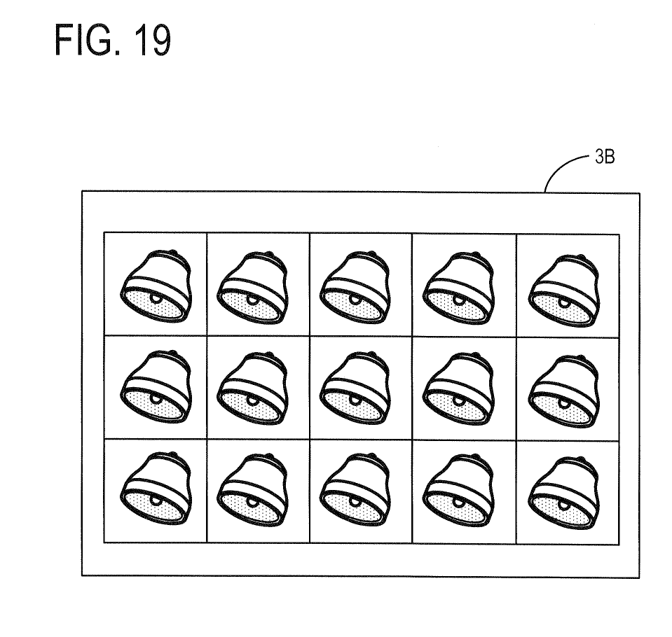

As mentioned above, in present invention, when a predetermined number or more of specific symbols are displayed, the reel is variably displayed on each of the symbol display portions on which the specific symbols are not displayed, meanwhile the specific symbols are fixedly displayed on each of the symbol display portions. After that, the symbols are stopped and displayed on each of the symbol display portions on which the specific symbols were not displayed. Then, if a combination of the symbols displayed on the symbol display portions correspond to the winning combination, an award corresponding to the winning combination will be provided to the player additionally. Therefore, entertainment aspect of the game may be enhanced. Also, the main CPU 42 determines whether or not an additional game will be executed according to the number of the specific symbols displayed on the symbol display portions. Therefore, the player can easily find out whether or not the additional game will be executed by counting the number of the specific symbols displayed on the symbol display portions. Also, as shown in FIG. 19, possibility that a lot of the specific symbols are stopped may be made because re-spin process is executed while the specific symbols are fixedly displayed. Therefore, entertainment aspect of the game may be enhanced because expectation of high-payout may be higher.

The present invention is not limited to above embodiments and various changes and modifications can be done within the scope of the present invention certainly.

Also, one or more aspects of the invention can be implemented as a playing method to execute above processes. Further, one ore more aspects of the invention can be implemented as a program to execute above processes in one or more computers, and a tangible medium in which the program is stored.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A gaming machine comprising:
a display that displays plural symbol display portions, each of the symbol display portions displaying a symbol; and
a processor programmed to:
(a) accept a start indication of a game,
(b) variably display the symbols on the symbol display portions when the start indication is accepted,
(c) stop the symbols on the symbol display portions,
(d) provide an award corresponding a winning combination if a combination of the displayed symbols is the winning combination,
(e) count number of specific symbols displayed on the symbol display portions,
(f) when the number of the specific symbols counted at (e) is same or more of than a predetermined number, fixedly display the specific symbol(s) on symbol display portion(s) and variably display symbols on symbol display portions on which the specific symbol(s) are not fixedly displayed,
(g) stop and display symbols on the symbol display portions on which the specific symbol(s) are not fixedly displayed, and
(h) additionally provide an award corresponding to a winning combination if a combination of symbols finally stopped and displayed on the symbol display portions is the winning combination.

2. A gaming machine comprising:
a display that displays plural symbol display portions, each of the symbol display portions displaying a video reel having symbols; and
a processor programmed to:
(a) accept a start indication of a game,
(b) variably display the video reels on the symbol display portions when the start indication is accepted,
(c) stop the symbols on the symbol display portions,
(d) provide an award corresponding a winning combination if a combination of the displayed symbols is the winning combination,
(e) count number of specific symbols displayed on the symbol display portions,
(f) when the number of the specific symbols counted at (e) is same or more of than a predetermined number, fixedly display the specific symbol(s) on symbol display portion(s) and variably display symbols on symbol display portions on which the specific symbol(s) are not fixedly displayed,
(g) stop and display symbols on the symbol display portions on which the specific symbol(s) are not fixedly displayed, and
(h) additionally provide an award corresponding to a winning combination if a combination of symbols finally stopped and displayed on the symbol display portions is the winning combination.

3. A gaming machine comprising:
a display that displays plural symbol display portions, each of the symbol display portions displaying a mechanical reel having symbols;
motors, each of the motors spinning and stopping the mechanical reel; and
a processor programmed to:
(a) accept a start indication of a game,
(b) variably display the mechanical reels on the symbol display portions by the motors when the start indication is accepted,
(c) stop the symbols on the symbol display portions,
(d) provide an award corresponding a winning combination if a combination of the displayed symbols is the winning combination,
(e) count number of specific symbols displayed on the symbol display portions,
(f) when the number of the specific symbols counted at (e) is same or more of than a predetermined number, fixedly display the specific symbol(s) on symbol display portion(s) and variably display symbols on symbol display portions on which the specific symbol(s) are not fixedly displayed,
(g) stop and display symbols on the symbol display portions on which the specific symbol(s) are not fixedly displayed, and
(h) additionally provide an award corresponding to a winning combination if a combination of symbols finally stopped and displayed on the symbol display portions is the winning combination.
